(19) United States
(12) Patent Application Publication
(10) Pub. No.: US 2005/0285591 A1
(43) Pub. Date: Dec. 29, 2005

(54) AC magnetic tracking system employing wireless field source

(76) Inventors: Robert F. Higgins, Richmond, VT (US); Mark N. Roussel, Milton, VT (US); Herbert R. Jones JR., Williston, VT (US); Allan G. Rodgers, Jericho, VT (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/147,977

(22) Filed: Jun. 8, 2005

Related U.S. Application Data
(60) Provisional application No. 60/578,128, filed on Jun. 8, 2004.

(51) Int. Cl. H01F 5/00

(52) U.S. Cl. 324/207.17

(57) ABSTRACT

A small, lightweight field source acts as a “pseudo-sensor” in an AC magnetic tracking system, facilitating wireless operation. Upon activation, the source sends out three continuous low-power magnetic signals, a separate frequency from each of three resonant orthogonal coils, without the need for switching to a receive mode or detecting a synchronizing signal to start the three signals simultaneously. This simple structure allows the source to be kept small and consume little power so that it can operate for over one hour before needing to be re-charged. This design approach thus allows a user or object being tracked to move about freely with no restricting cabling to a base station or even to a body-mounted electronics module and bulky battery. A family of frequencies can be used for each of several such pseudo-sensor sources in order for the base station sensors and electronics to track multiple sources.

### REFERENCE TO RELATED APPLICATION

This application claims priority to U.S. Provisional Patent Application Ser. No. 60/578,128, filed Jun. 8, 2004, the entire content of which is incorporated herein by reference.

### FIELD OF THE INVENTION

This invention relates generally to AC magnetic tracking systems and, in particular, to systems of this type which are entirely wireless.

### BACKGROUND OF THE INVENTION

Position and orientation tracking systems (“trackers”) are well known in the art. For example, U.S. Pat. Nos. 4,287,809 and 4,394,831 to Egli et al.; U.S. Pat. No. 4,737,794 to Jones; U.S. Pat. No. 4,314,251 to Raab; and U.S. Pat. No. 5,453,686 to Anderson, are directed to AC electromagnetic trackers. U.S. Pat. No. 5,645,077 to Foxlin discloses an inertial system, and combination systems, consisting or two different trackers, such as optical and magnetic, are described in U.S. Pat. No. 5,831,260 to Hansen and U.S. Pat. No. 6,288,785 B1 to Frantz et al. Other pertinent references include U.S. Pat. No. 5,752,513 to Acker et al. and U.S. Pat. No. 5,640,170 to Anderson.

AC electromagnetic trackers have definite advantages over other types of systems. For one, AC trackers provide the highest solution/update rate with the greatest accuracy, not affected by obstructed field of view, in contrast to optical solutions. AC trackers do not require reference sensor/unit and drift stable apparatus of the type required by inertial units, and they are not affected by the Earth's magnetic field and the magnetization of ferrous materials, in contrast to DC magnetic systems.

Typical AC magnetic trackers operate with a magnetic field source in a fixed position. Fields from this source are coupled to one or more sensors which can then be tracked in the immediate volume nearby. One of the reasons this static source configuration has been used is due to the fact that the drive for the field source typically requires considerable drive current. The attendant power circuitry have made tethering the source through a cable to an electronics unit the most convenient and practical way of operating the system. This configuration also allows the complex set of signals intercepted by the sensors to be conveyed back to the same electronics unit where synchronism, amplification, digitization, etc. can be accomplished in a single unit. Theoretically speaking, however, the calculations of P&O between source and sensor are completely reciprocal such that a sensor, or sensors, could be held static while the field sources are moved about and tracked.

A magnetic tracking system (FIG. 1) consists of at least one field source (1), usually consisting of a triad of orthogonal coils for creating signals in all three of the Cartesian coordinates, and at least one sensor (2), also usually consisting of a triad of orthogonal coils, so that coupling in all dimensions can be effected. There is a processor (3) and drive circuitry (4) for creating the fields, circuitry for amplifying and digitizing (6) the sensed signals and circuitry and processing algorithms to synchronize the data, provide filtering, calibration, coordinate translations, etc. and produce the desired P&O of the relative position and orientation between source and sensor.

If one desires a remote “sensor” to track, it really does not matter whether the source or sensor is tracked because the P&O calculation is the relative position and orientation between source and sensor. If adequate sensitivity and low noise performance can be achieved with the sensor and a means can be found to determine the source frequency set and become synchronized with this external source of orthogonal fields, then the source can be remoted as a wireless pseudo-“sensor.” This reciprocity of the tracking relationship is shown in FIG. 2 where the wireless source is the “sensor” (1), whose signals are detected by a true sensor (2) connected to the tracker electronics unit (3) being powered by local power mains and is connected to the host computer where the results are utilized.

There has been considerable interest in recent years to be able to have wireless sensors on a subject in order to allow freedom of movement unencumbered by one or more cables. With magnetic trackers, this has only been possible by providing sensor circuitry in an electronics pack on the subject for processing the sensor signals and then radio link via RF back to the base station that drives the field source. In order to power this grouping of sensors and associated processing circuitry, an additional battery pack is typically provided on the body. These items still considerably constrain free movement of the subject and tend to be uncomfortable to wear not only from being cumbersome but because they cause perspiration from heat and lack of ventilation. Furthermore, they are difficult to keep running reliably because of the many interconnections involved and the cables being threaded through garments or other items on the subject.

U.S. Pat. No. 6,188,355 to Gilboa discusses a wireless signal source. In one embodiment there is a requirement to switch the wireless source and the tracking sensors back and forth between transmit and receive in order to obtain synchronization between them. In another embodiment, there is a requirement that the three frequencies generated, one for each leg of the transmitting coil, be harmonically related. In yet another embodiment, reception of a threshold triggering event in order to start all transmitted signals in unison is explained. These constraints, plus a requirement to perform calibrations at over 32 position and 32 orientation settings, leads to significant complexity.

Indeed, any attempt to provide magnetic sensors with wireless leads cause difficult engineering problems: 1) size must be kept as small as possible, thereby intercepting little energy; 2) the signals measured must at the very least be amplified, causing a need for remote circuitry on the body; 3) digitization of the measured signals is much preferred since these digital representations limit the amount of signal degradation that can occur but adds more circuitry to be housed remotely on the body; and 4) either analog data, digitized data or finished P&O answers must be radio linked back to a base station so the final answers can be computed and utilized, again causing an RF link and the consumption of more space and more battery power.

One way to circumvent this complexity would be to generate a magnetic source signal with wireless electronics which is then intercepted by static sensors already at a base station where few constraints exist for providing amplification, digitization, computation and data distribution. The challenge is to 1) generate the field signals efficiently in order to minimize circuitry, size and power consumption and do so where several frequency sets can be created to have several uniquely identifiable sources, and 2) be able at the sensor(s) to synchronize with the signals generated in order to extract the data needed to compute P&O and maintain that synchronization.

### SUMMARY OF THE INVENTION

This invention resides in AC magnetic trackers wherein a three-dimensional source of fields can be tracked without providing (wired) power, drive signals or RF communication signals. Further, it receives no signals from the tracker system. As such, the source can be entirely wireless.

In existing AC magnetic tracking systems a magnetic field source is held statically and sensors are positioned on a subject or object to be tracked. The difficulties of dealing with these low-level signals on the body, and the necessity of radioing the resulting data back to a base station, make a wireless source according to the invention especially attractive. This invention takes advantage of the fact that the tracking of position and orientation (P&O) between source and sensor is entirely reciprocal; that is, it makes no difference that the source is moving and the sensor is held static.

According to the invention, a small, lightweight wireless source acts as a “pseudo-sensor” source. Upon activation, the source sends out three continuous low-power magnetic signals, a separate frequency from each of three resonant orthogonal coils, without the need for switching to a receive mode or detecting a synchronizing signal to start the three signals simultaneously. This simple structure allows the source to be kept small and consume little power so that it can operate for over one hour before needing to be re-charged. This design approach thus allows a user or object being tracked to move about freely with no restricting cabling to a base station or even to a body-mounted electronics module and bulky battery.

A family of frequencies can be used for each of several such pseudo-sensor sources in order for the base station sensors and electronics to track multiple sources and do so in an enlarged environment because the low signal levels and close source-sensor spacing yield little opportunity to create detectable eddy current distortion. The tracker electronics unit is able to determine signal synchronization and resolve phase ambiguities to intercept the needed signals. Characterization of the source minimizes the effects of circuitry and battery packaged close to the source in the normal process of optimizing the usual coil variables.

In the preferred embodiment, a wireless field source is tracked using a commercial tracker system based upon a single passive 3-axis sensor. In order to cover a larger volume over which 6 degree-of-freedom P&O tracking occurs, use of more sensors is possible, which allows for increased tracking volume with minimal concerns for field distortions due to the low power signals used.

### BRIEF DESCRIPTION OF THE DRAWINGS

FIG. 1 is a block diagram of a typical AC magnetic tracking system;

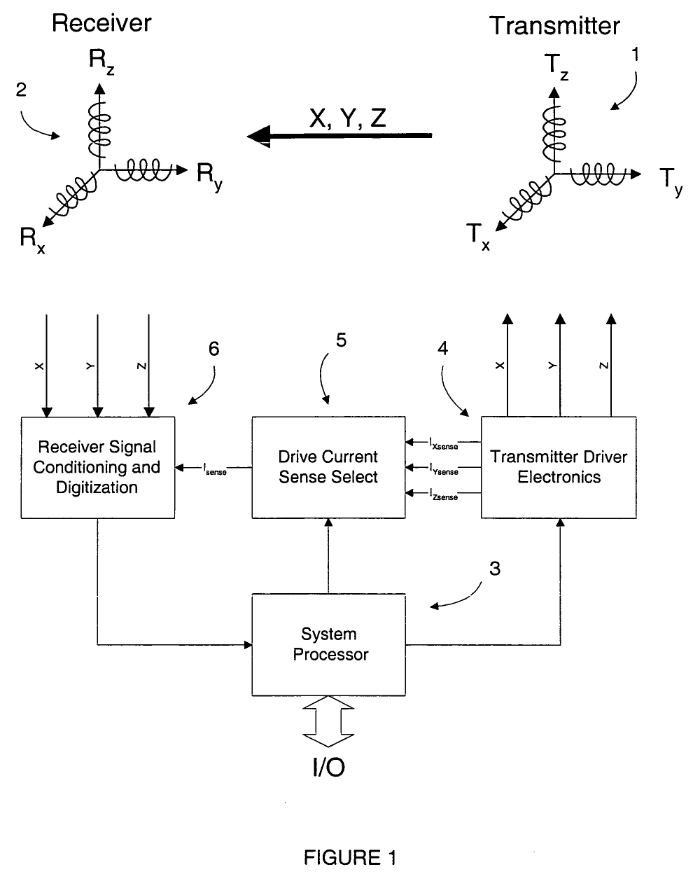

FIG. 2 is a block diagram of a wireless tracker according to the invention including an electronics unit that takes characterization information into account based upon recognition of the presence of the frequencies of a particular source;

FIG. 3 depicts one embodiment of a wireless sensor according to the invention; and

FIG. 4 shows how a string of single sensors can extend the tracking range of such non-coherent pseudo-sensor sources by successively picking up and tracking their magnetic fields.

### DETAILED DESCRIPTION OF THE INVENTION

The expression “frequency set” is used herein to convey the notion that this invention is dependent on creating three independent frequencies, one on each of three coils intended to be arranged geometrically orthogonal to each other, so that the tracker electronics and true sensor intercepting the magnetic field signals can distinguish the proper source axes. For a given system, the frequency sets should be arranged identically from unit-to-unit, and additional frequency sets are chosen so that multiple sources “pseudo-sensors” can navigate in the same environment without repeating frequencies from other pseudo-sensors.

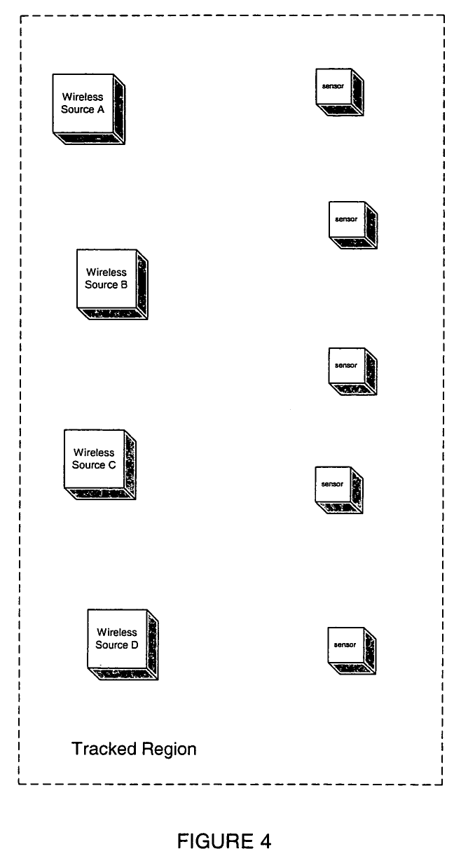

According to the invention, the tracking of the pseudo-sensor(s) can be accomplished with a single, three-axis set of true sensor coils. The pseudo-sensor source can also be kept quite simple as a self-standing source of the three magnetic fields. As such, the pseudo-sensor source simply creates the signals to be tracked without the need to revert to receiving signals. Nor does the pseudo-sensor need to detect a threshold event to start tracking, as in the previous art. Furthermore, a string of single sensors can extend the tracking range of such non-coherent pseudo-sensor sources by successively picking up and tracking their magnetic fields (see FIG. 4).

High sensitivity and low noise performance on the true sensor end of the system are key to achieving a working system with such a “sensor.” In other words, excellent SNR (signal-to-noise ratio) performance is required if the wireless portion is to be kept as simple and durable as possible. A wireless package requires minimal circuitry to generate the drive signals, not only to keep the device small but to achieve low battery drain so that the battery also can be kept small and still provide a reasonable operating time of at least one hour before recharging is necessary. Another aspect of the invention includes innovations in mechanical packaging to: 1) keep the “sensor” as small as possible; 2) make it reliable and rugged; and 3) minimize any unwanted magnetic field effects that may be brought on by housing the drive circuitry and battery very near to the source coil windings.

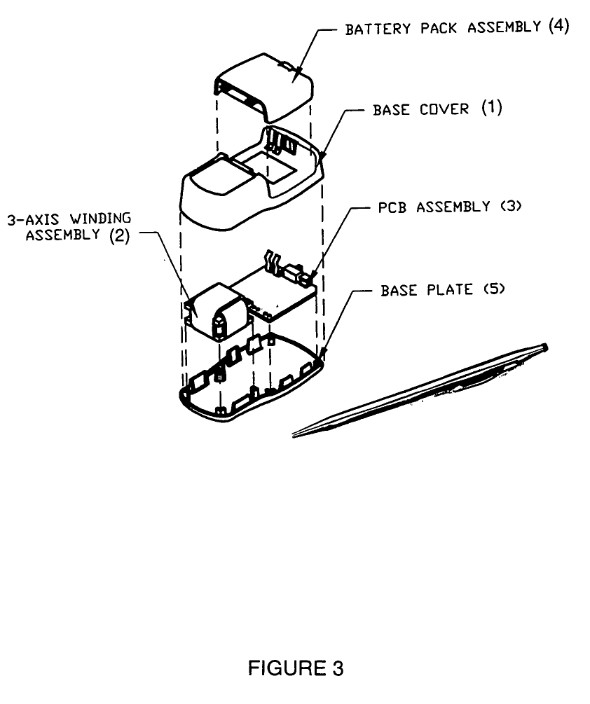

One embodiment of a wireless sensor is shown in FIG. 3. A set of orthogonal 3D coils (2) is connected to, and driven by, circuitry on a small printed circuit board (3), which in turn is powered by a slender rechargeable battery (4). The battery purposely is spaced away from the coils on the opposite side of the printed circuit board both for ease of access and to place it as far as possible from influencing operation of the coils. A molded shell/case (1) and cover (5) enclose and protect the circuitry and source coils. The cover allows easy access to the battery for recharging and/or replacement.

The source coil windings (2) are applied around a bobbin which may or may not contain a ferrite core to passively increase the generated field. The sample package dimensions at approximately 1×1.5×2 inches make it compact enough for easy use but still is large enough to produce acceptable signal levels and provide direct access to the battery for re-charging.

Many factors are available in an AC magnetic system for maximizing the field output from the source coils. Considerations include: providing as many coil turns as feasible, driving it harder, operation at higher frequencies, imbedding a ferrite in its core to raise permeability as indicated in FIG. 3, and operating in the tuned circuit mode. Though all of these factors can be used to maximize signal strength and minimize battery drain, not all may be necessary to a given application.

In order to achieve the best tracking accuracy for each wireless source produced, a process known as characterization can be used to reduce the effects of inevitable variations in each unit manufactured such as orthogonality, non-concentricity, winding uniformity, etc. Reference is made to U.S. Pat. No. 5,307,072, the entire content of which is incorporated herein by reference. Furthermore, this same characterization process automatically includes the effects of nearby elements, such as the circuit board and the battery, in optimizing the several source variables.

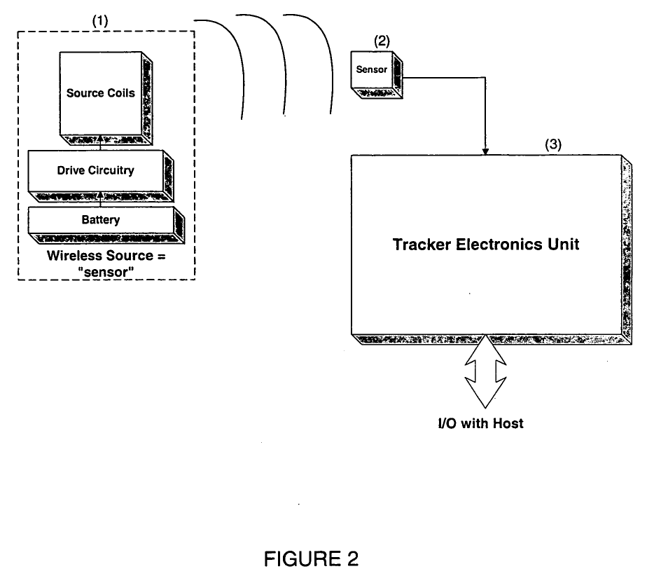

The Tracker Electronics Unit (TEU, item (3) in FIG. 2) can take the characterization information into account based upon recognition of the presence of the frequencies of a particular source. In fact, trackers have been quite accustomed to performing characterization compensation of this sort for many years, and the process for determining characterization after the manufacturing process has been in place for at least fifteen years. The result is improved accuracy and minimization of any effects the nearby circuit board and battery may have on the ideal dipole fields normally achieved from such coils.

On the other end of the system, in the electronics unit, the system processor must know the frequency of the source signal(s), synchronize with it and perform the mathematics necessary to track wireless source(s) using one or more sensors. The process of tracking both wired and wireless sources is described in co-pending U.S. Provisional Patent Application Ser. No. 60/577,860, the entire content of which is also incorporated herein by reference.

In operation: 1) The tracker with true sensor, or sensors, is started where the sensor(s) position is static and known; 2) the wireless source battery is snapped into place so that a signal starts emanating from its coils; 3) meanwhile the TEU has been searching for signals over the expected frequency range; 4) as the wireless source is brought into range its frequency set is recognized and its characterization is retrieved from TEU memory or is downloaded from its host computer; 5) the sensor circuitry which amplifies and digitizes the signals achieves synchronization with the source signals; 6) data are collected, filtered and used to produce a sensor signal matrix representing the response of each axis of the sensor(s) to each axis of the source; 7) characterization for both sensor and source is applied to the signal matrix, along with any other system calibration data; 8) the data enters the P&O algorithm; 9) output parameters are manipulated into the format established by the host computer; and 10) output of P&O is communicated to the host.

1. A field source adapted for use with an AC magnetic tracking system including at least one sensor having a set of coils for detecting frequencies emanating from the source and processing electronics operative to determine the position and orientation of the source based upon the frequencies detected by the sensor, the source comprising:
a housing including the following components:
a set of coils;
a battery; and
circuitry operated by the battery for driving each coil to generate a different frequency.

2. The field source of claim 1, including a set of three orthogonal coils.

3. The field source of claim 1, wherein the battery is intentionally physically separated from the set of coils to minimize interference.

4. A tracking method, comprising the steps of:
providing the field source of claim 1;
generating a sensor signal matrix representing the response of each coil of the sensor to each coil of the source; and
calculating the position and orientation of the source using the signal matrix.

5. The method of claim 6, including the steps of:
storing characterization information regarding the source, the sensor, or both; and
applying the characterization information to the signal matrix.

6. A wireless AC magnetic tracking system, comprising:
a battery-operated, wireless magnetic field source including a first set of coils and circuitry to drive each coil at a different frequency;
a sensor having a second set of magnetic field coils, each coil being operative to detect one of the frequencies generated by the source; and
processing electronics connected to the sensor operative to determine the position and orientation of the source based upon the frequencies and signal matrix detected by the sensor.

7. The tracking system of claim 6, wherein the source and sensor each include a set of three orthogonal coils.

8. The tracking system of claim 6, wherein the sensor is stationary.

9. The tracking system of claim 6, including a plurality of sensors.

10. The tracking system of claim 6, including a plurality of sources, each source including a set of coils driven at different frequencies.

11. A tracking method, comprising the steps of:
providing the system of claim 6;
generating a sensor signal matrix representing the response of each coil of the sensor to each coil of the source; and
calculating the position and orientation of the source using the signal matrix.

12. The method of claim 11, including the steps of:
storing characterization information regarding the source, the sensor, or both; and
applying the characterization information to the signal matrix.
